(19) United States
(12) Patent Application Publication
(10) Pub. No.: US 2007/0079271 A1
(43) Pub. Date: Apr. 5, 2007

(54) Design tool, design method, and program for semiconductor device

(75) Inventor: Kenichi Ushiyama, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/339,468

(22) Filed: Jan. 26, 2006

(30) Foreign Application Priority Data
Sep. 21, 2005 (JP) 2005-273947

(51) Int. Cl. G06F 17/50

(52) U.S. Cl. 716/6

(57) ABSTRACT

A design tool, which is capable of designing an IC in which no malfunctions occur during a normal operation and a test, by limiting the amount of noise produced by the operation of an SRAM during the normal operation of the IC itself and during the test of the IC, has been disclosed. The design tool is for a semiconductor device having plural SRAMs in one chip, comprising a simultaneous operation noise amount calculation section for estimating AC noise produced by the simultaneous operation of the SRAMs and performing design such that the estimated AC noise is less than the permitted amount of noise.

### BACKGROUND OF THE INVENTION

The present invention relates to a design tool, a design method, and a program for a semiconductor device (IC) having plural SRAMs on one chip.

A semiconductor device (IC) mounting many independent SRAMs on one chip is used and there are some mounting one hundred independent SRAMs on one chip. An SRAM is configured so as to perform a pipeline operation in accordance with an input clock and when a clock is input, even if input/output operations are not performed, part of the internal circuit will operate.

Such an IC is prepared as part of an ASIC and used in various forms according to requests from users. For example, only SRAMs are mounted on an IC and the IC is used in combination with an IC mounting a multiprocessor etc., or used with other elements such as a multiprocessor mounted on the same chip. For an IC, a basic configuration is specified and design such as wiring is performed according to requests of users. Usually, design is performed automatically, however, there may be a case where an operator modifies a design by a manual operation at his/her discretion.

The present invention relates to design for such a semiconductor device (IC) mounting many independent SRAMs on one chip.

For such an IC described above, it is necessary to conduct various tests at the time of manufacture and test circuits are incorporated in the IC. For example, in a test on an SRAM, after data is written into each memory cell, it is read and whether or not the read data is equal to the written data is checked. The data to be written is different values (in a case of two-value data, 0 or 1) and it is necessary to write data into a memory cell array in various patterns for confirmation. Accordingly, the test takes a considerably long time. Therefore, to shorten the test time, the number of memory cells that can be accessed simultaneously with test circuits is increased. U.S. Pat. No. 5,717,643 has described a semiconductor memory device provided with test circuits.

FIG. 1 is a diagram showing a processing process in a CAD tool that makes a design for such an IC as described above. A CAD tool is realized with a computer. In step S11, macro arrangement processing for arranging each component in a chip is performed and layout data is created. In step S12, power wiring processing for arranging power lines to each component is performed. In step S13, the test circuit described above is inserted. In step S14, arrangement wiring processing for arranging clock lines, control signal lines, and signal lines of address bus, data bus, etc., is performed. In step S15, timing adjustment processing for adjusting supply timing of a clock and various signals to each component. Timing adjustment is performed by utilizing a timing buffer circuit to be provided in an IC.

The design for an IC as described above is made so as to meet the specifications required by users, and although it is unlikely that all of the plural SRAMs are accessed simultaneously, supply of a clock to each SRAM is not particularly specified for a conventional design tool (CAD tool) that performs automatic design, and basically, clocks are supplied to all of the SRAMs. Therefore, while an SRAM is being accessed, the internal circuits of other SRAMs not used simultaneously are in an operating state. In order to save power, termination of supply of a clock to the SRAMs not used simultaneously may be done and this processing is performed manually by an operator. The supply of a clock to the SRAMs is performed by using a gating circuit.

### SUMMARY OF THE INVENTION

An object of the present invention is to solve these problems and to make it possible to design an IC that does not cause malfunctions during the normal operation and the test by limiting the amount of noise produced by the operation of SRAMs during the normal operation of the IC itself and during the test of the IC.

In order to realize the above-mentioned object, the design tool, the design method, and the program of the present invention estimate the AC nose produced by the simultaneous operation of SRAMs and perform design such that the estimated AC noise is less than a permitted amount of noise.

According to the present invention, design is performed such that the AC noise produced by the simultaneous operation of the SRAMs during the normal operation and the test is less than the permitted amount of noise and, therefore, the effect can be obtained that malfunctions are prevented and the reliability of an IC mounting plural SRAMs and of the test is improved.

### BRIEF DESCRIPTION OF THE DRAWINGS

The features and advantages of the invention will be more clearly understood from the following descriptions taken in conjunction with the accompanying drawings in which:

FIG. 1 is a flow chart showing design processing of a conventional IC;

FIG. 2 is a diagram showing a configuration of a semiconductor device (IC) to be designed of the present invention;

FIG. 3 is a block diagram showing a circuit configuration of an SRAM;

FIG. 4 is a diagram showing an entire configuration of hardware of a design (CAD) tool;

FIG. 5 is a functional block diagram of a CAD tool in an embodiment;

FIG. 6 is a flow chart showing a design procedure of an IC having plural SRAMs in an embodiment; and

FIG. 7 is a flow chart showing SRAM simultaneous operation number processing in an embodiment.

### DESCRIPTION OF THE PREFERRED EMBODIMENTS

A circuit produces AC noise when it operates. In a normal circuit such as a gating circuit, the amount of produced noise is small because it operates by a pulse-like signal, however, for an SRAM, the width of a pulse is relatively large and the amount of produced noise becomes relatively large because of accesses to a memory cell. Therefore, if the number of simultaneously operating SRAMs increases, there arises a problem that the amount of produced noise increases and malfunctions occur.

As described above, in the conventional design tool, when a design is made for an IC having plural SRAMs, supply of a clock to each SRAM is not particularly specified and, in the case of automatic design, the design is made such that all of the SRAMs operate. The conventional IC has a small number of SRMAs mounted thereon and, therefore, such design does not bring about problems particularly. However, recently, the number of SRAMs mounted on one chip has increased the amount of produced noise has increased accordingly, and the occurrence of malfunctions cannot be ignored.

Further, as described above, when the test circuit is provided in the IC mounting plural SRAMs, an attempt is made to improve the efficiency of the test by increasing the number of SRAMs to be tested simultaneously. However, if the number of simultaneously operating SRAMs increases, a large amount of AC noise is produced, malfunctions occur, and there arises a problem that a correct test cannot be conducted. The influence of the AC noise is greater for an IC that operates at a high speed and malfunctions are more likely to occur.

According to the present invention, the AC noise produced by the simultaneous operation of SRAMs is estimated and design is performed such that the estimated AC noise is less than the permitted amount of noise, therefore, it is possible to prevent malfunctions during the normal operation and the test. Specifically, the number of simultaneously operatable SRAMs is determined such that the estimated AC noise is less than the permitted amount of noise and design is performed such that the number of simultaneously operating SRAMs is equal to or less than that. The operation of the SRAMs is performed by setting the operation state of the gating circuit that controls supply of a clock to each SRAM. The SRAM does not operate if a clock is not supplied, therefore, no AC noise is produced and power consumption also is reduced.

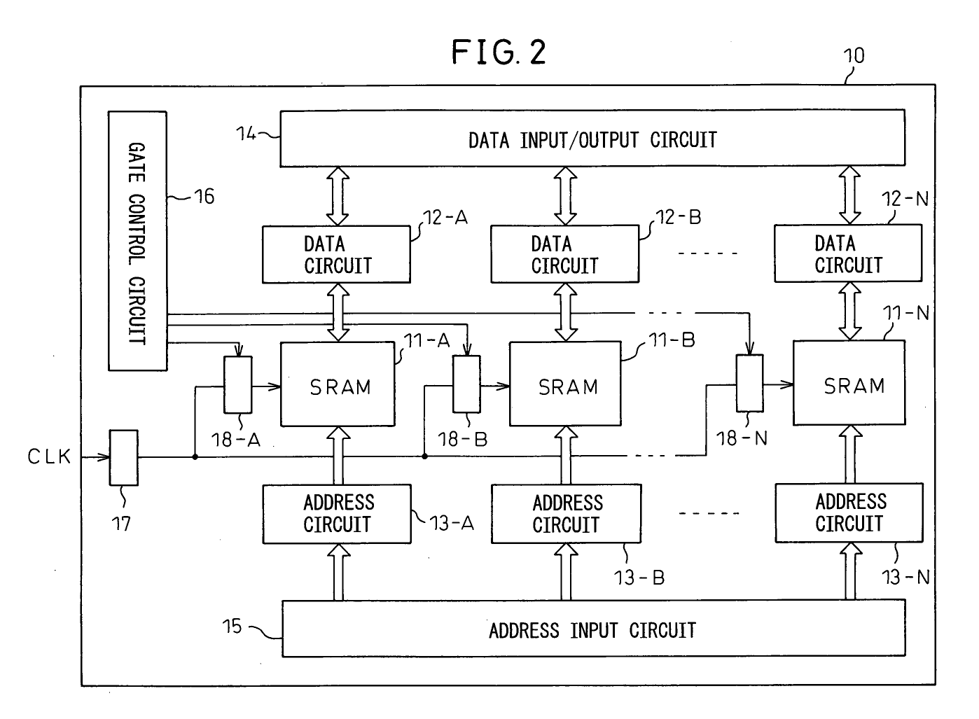

FIG. 2 is a block diagram showing a configuration of a semiconductor device (IC) 10 to be designed by a design tool (a CAD tool) of the present invention. As shown schematically, the IC 10 has plural SRAMs 11-A, 11-B, . . . , 11-N. There are provided data circuits 12-A, 12-B, . . . , 12-N and address circuits 13-A, 13-B, . . . , 13-N in order to access each SRAM. Input/output of data between the data circuits 12-A, 12-B, . . . , 12-N and the outside is performed via a data input/output circuit 14 and similarly, input/output of data between the address circuits 13-A, 13-B, . . . , 13-N and the outside is performed via an address input circuit 15. According to the design for the data input/output circuit 14 and the address input circuit 15, connection between external connection terminals and each data circuit and between electrode pads other than the external connection terminals and each data circuit is determined. The data input/output circuit 14 and the address input circuit 15 are determined according to the specifications of users. By the way, the data input/output circuit 14 and the address input circuit 15 are provided also with a test circuit and it is made possible to access an SRAM during the test other than those during the normal operation, for example, to access more SRAMs during the test than during the normal operation.

A clock CLK is supplied to the SRAMs 11-A, 11-B, . . . , 11-N and each SRAM performs a pipeline operation in accordance with the clock. The clock CLK input from the outside is input to a clock buffer 17 and supplied to each SRAM via gating circuits 18-A, 18-B, . . . , 18-N provided in accordance with each SRAM. The respective gating circuits 18-A, 18-B, . . . , 18-N are controlled by a gate control circuit 16 and the supply of the clock to the SRAM is terminated by putting the gating circuit to rest and the SRAM stops operation. While the SRAM is being supplied with the clock, the internal circuit is in operation even if no access is made to the memory cell, and produces AC noise and consumes power, however, if the supply of the clock is terminated, the internal circuit stops operation and access to the memory cell cannot be made, therefore, no AC noise is produced and power consumption is reduced.

By the way, the gating circuits 18-A, 18-B, . . . , 18-N are provided also with a function of a timing buffer circuit for adjusting the timing of the clock to be supplied and outputting it, and the timing of the clock is set such that the amount of delay of the clock to be supplied to each SRAM is adjusted to attain a normal operation. The timing of the clock to be supplied to each SRAM has a tolerance to a certain extent and normal operation is possible if it is within tolerance. By adjusting the timing of the clock within this tolerance, it is possible to change the timing of the production of AC noise.

In FIG. 2, only portions relating to the SRAM are shown, however, other circuitry parts such as a microprocessor may be provided in the IC 10.

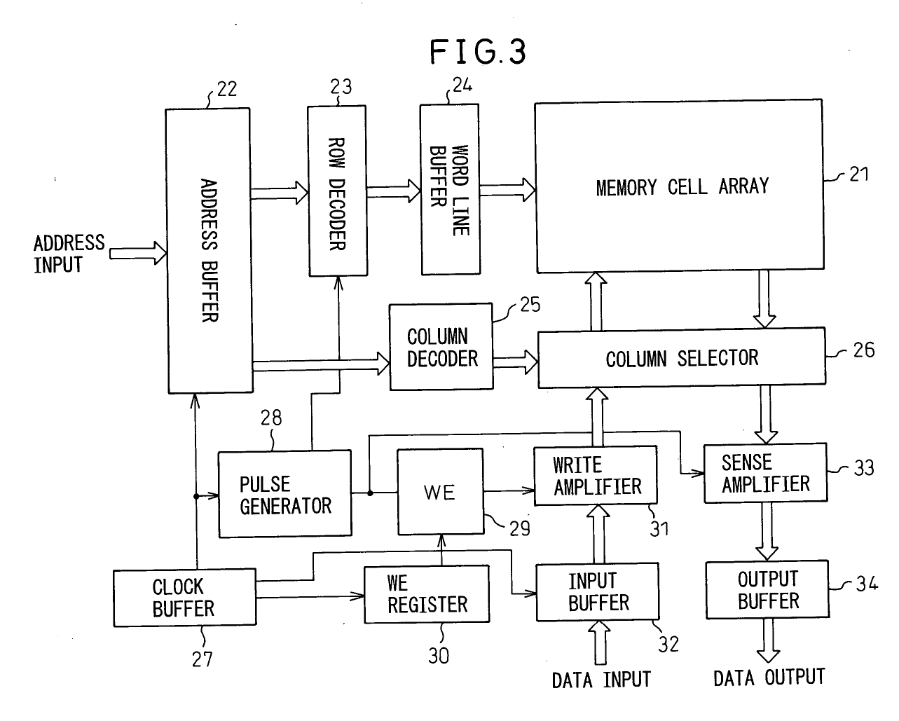

FIG. 3 is a diagram showing a circuit configuration of an SRAM. As shown schematically, an SRAM has a memory cell array 21, an address buffer 22, a row decoder 23, a word line buffer 24, a column decoder 25, a column selector 26, a clock buffer 27, a pulse generator 28, a write enable pulse generator 29, a write enable register 30, a write amplifier 31, an input buffer 32, a sense amplifier 33, and an output buffer 34. The configuration of this SRAM is widely known, therefore, its explanation is omitted.

The IC 10 having the plural SRAMs explained in FIG. 2 and FIG. 3 is designed using a design tool (a CAD tool) in accordance with the specifications of users.

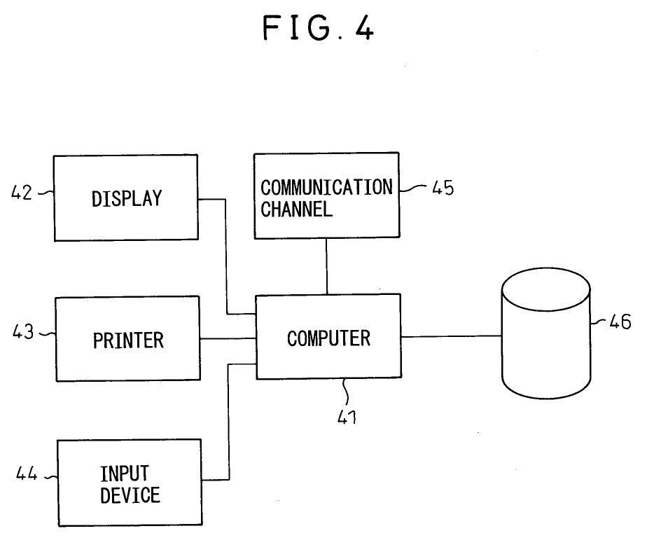

FIG. 4 is a diagram showing an entire configuration of a CAD tool. As shown schematically, the CAD tool comprises a computer 41, a display 42, a printer 43, an input device 44 such as a keyboard and a mouse, a communication channel 45 such as a LAN, a storage device 46 with stored layout data, etc. Various functions are realized with programs. As the configuration of a CAD tool is widely known, an explanation is omitted.

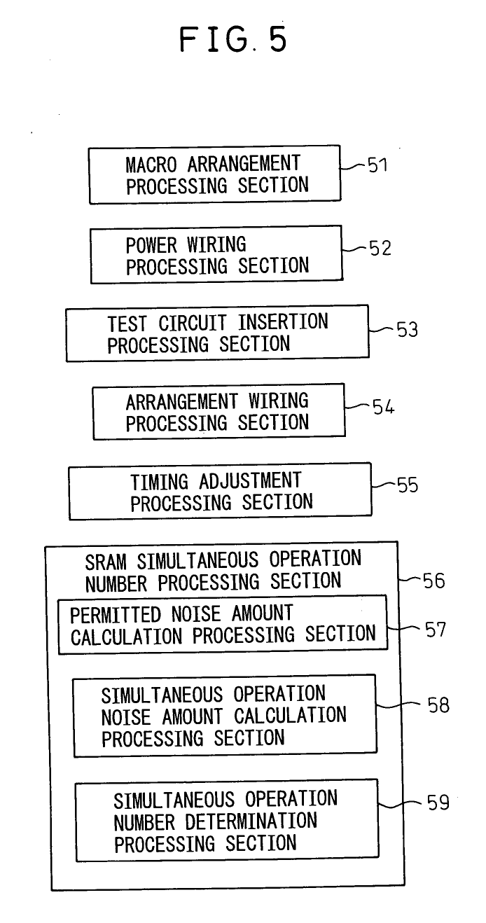

FIG. 5 is a functional block diagram of a CAD tool in an embodiment. As shown schematically, the CAD tool is provided with functional sections provided in a conventional CAD tool, such as a macro arrangement processing section 51, a power wiring processing section 52, a test circuit insertion processing section 53, an arrangement wiring processing section 54, and a timing adjustment processing section 55. What are shown schematically are only parts of the functional sections and many other functional sections are also provided. In addition to such conventional functional sections, the CAD tool in the embodiment has an SRAM simultaneous operation number processing section 56. The SRAM simultaneous operation number processing section 56 has a permitted noise amount calculation processing section 57, a simultaneous operation noise amount calculation processing section 58, and a simultaneous operation number determination processing section 59.

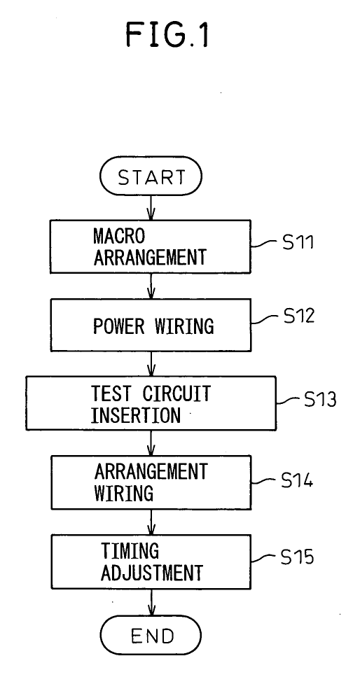

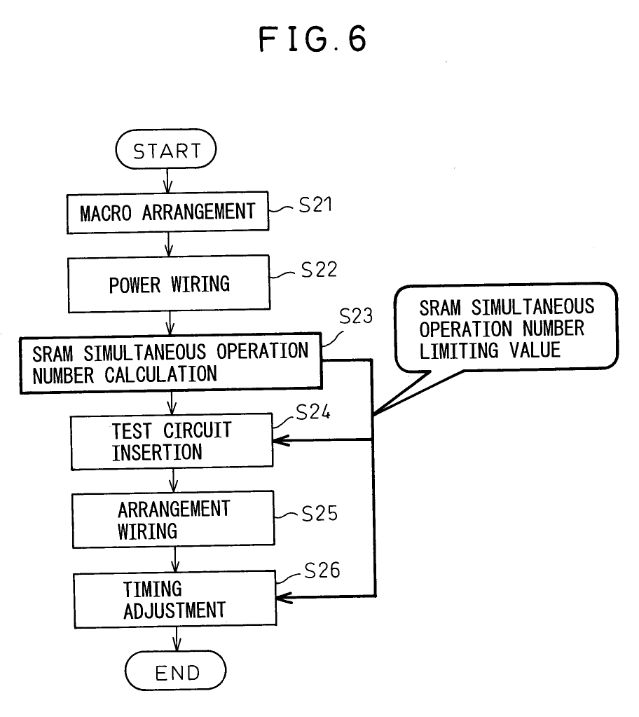

FIG. 6 is a flow chart showing processing when an IC is designed using the CAD tool in the embodiment. This differs from the flow chart in FIG. 1 in that SRAM simultaneous operation number calculation processing S23 is performed between power wiring processing S22 and test circuit insertion processing S24 and the number of simultaneously operating SRAMs determined in the SRAM simultaneous operation number calculation processing S23 is reflected in the test circuit insertion processing S24 and timing adjustment processing S26. Processing other than the SRAM simultaneous operation number processing is the same as the conventional processing, therefore, an explanation is omitted and only processing relating to the number of simultaneously operating SRAMs is explained.

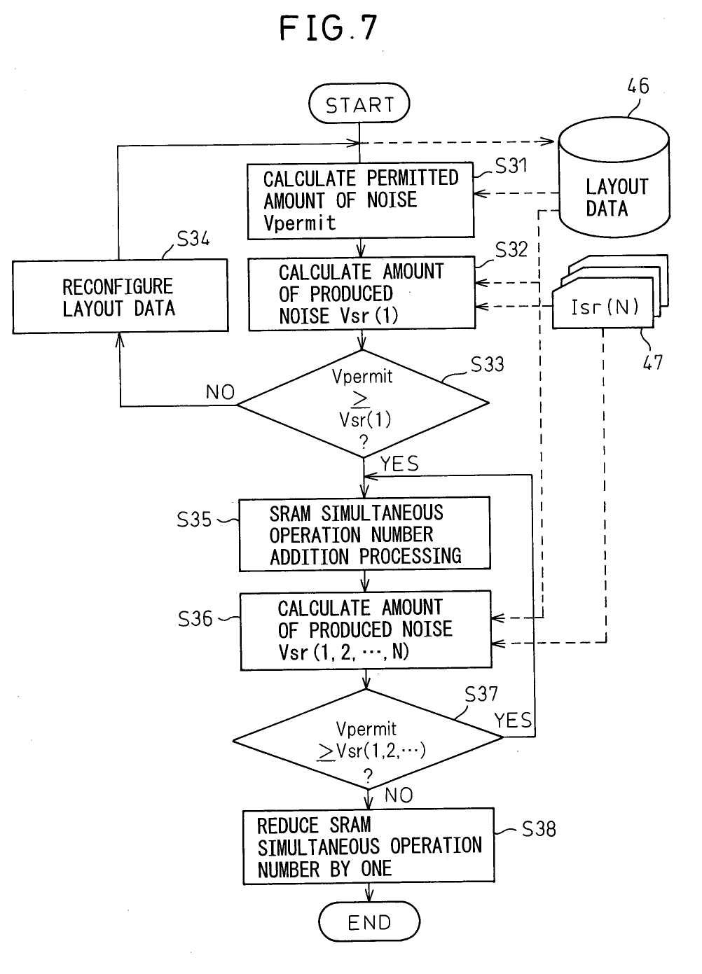

FIG. 7 is a flow chart showing processing relating to the number of simultaneously operating SRAMs in the embodiment. Here, the macro arrangement processing and the power wiring processing are completed and layout data is stored in the storage device 46. Further, a library 47 for each SRAM is stored in the storage device 46 and an amount of change in current Isr (N) (N is the number of the SRAM) of an SRAM included in each SRAM is stored.

In step S31, a permitted amount of noise Vpermit is calculated from the layout data stored in the storage device 46. The permitted amount of noise Vpermit is assumed to be the maximum value with which a circuit does not malfunction.

In step S32, an amount of produced noise Vsr (1) of a first SRAM is calculated from the layout data and an amount of change in current Isr (1) of the first SRAM (1) included in the library 47. Here, an amount of noise produced by the change in current of the first SRAM (1) is assumed to be Vsr (1).

In step S33, whether Vsr (1) is equal to or less than Vpermit is confirmed. If Vsr (1) is greater, it is necessary to proceed to step S34, in which the layout data is reconfigured so as to increase Vpermit, and return to step S31. The reconfigured layout data is stored in the storage 46. If Vsr (1) is less than Vpermit, step S35 is entered.

In step S35, simultaneous operation number addition processing to increase the number of SRAMs to be operated simultaneously is performed.

In step S36, as in step S32, the amount of produced noise Vsr (1, 2, . . .) of the SRAMs with the current number by adding the amount of produced noise of the added SRAM.

In step S37, whether Vsr (1, 2, . . .) is equal to or less than Vpermit is judged and when Vsr (1, 2, . . .) is less than Vpermit, the flow returns to step S35 and steps S35 to S37 are repeated until Vsr (1, 2, . . .) exceeds Vpermit. When Vsr (1, 2, . . .) exceeds Vpermit, the flow proceeds to step S38, in which the current number of SRAMs N is reduced by one and N-1 is set to a simultaneous operation number limiting value.

As shown in FIG. 6, a test circuit is inserted in step S24 such that the SRAM simultaneous operation number limiting value determined as described above is met. Further, in step S26, timing is adjusted such that the SRAM simultaneous operation number limiting value is met by utilizing the function of the timing buffer circuit provided in the gating circuits 18-A, 18-B, . . . , 18-N.

Although the embodiment of the present invention is explained as above, it is needless to say that various modifications are possible. For example, it is preferable that the permitted amount of noise and the amount of simultaneous operation noise be calculated by a calculation method suitable to the IC to be designed.

Further, if a program for SRAM simultaneous operation number processing characterized by the present invention is added to a conventional CAD tool, a CAD tool having the characteristics of the present invention can be realized.

The present invention can be applied to any design provided it is for a semiconductor device (IC) having plural SRAMs

We claim:

1. A design tool for a semiconductor device having plural SRAMs in one chip, comprising a simultaneous operation noise amount calculation section for estimating AC noise produced by the simultaneous operation of the SRAMs, wherein design is performed such that the estimated AC noise is less than a permitted amount of noise.

2. The design tool as set forth in claim 1, further comprising a permitted noise amount calculation section for calculating the permitted amount of noise from the layout data of the semiconductor device.

3. The design tool as set forth in claim 2, wherein the permitted noise amount calculation section defines the maximum value of an amount of noise with which the circuit of the semiconductor device does not malfunction as the permitted amount of noise.

4. The design tool as set forth in claim 1, further comprising a library that has defined an amount of change in current when the SRAM is in operation, wherein the simultaneous operation noise amount calculation section estimates the AC noise when the SRAMs are simultaneously in operation from the amount of change in current.

5. The design tool as set forth in claim 1, wherein the layout data is recreated when the AC noise estimated by the simultaneous operation noise amount calculation section is greater than the permitted amount of noise.

6. The design tool as set forth in claim 1, further comprising a simultaneous operation number determination section for determining the number of simultaneously operatable SRAMs such that the estimated AC noise is less than the permitted amount of noise.

7. The design tool as set forth in claim 6, wherein:
the semiconductor device comprises a gating circuit for controlling supply of a clock to each SRAM; and
the design tool further comprises a gating circuit operation setting section for setting the gating circuit such that the number of simultaneously operating SRAMs is equal to or less than the number of simultaneously operatable SRAMs determined by the simultaneous operation number determination section.

8. The design tool as set forth in claim 7, wherein:
the semiconductor device further comprises a timing buffer circuit for controlling supply timing of the clock to each SRAM; and
the design tool further comprises a gating timing setting section for setting the timing buffer circuit such that the number of simultaneously operating SRAMs is equal to or less than the number of simultaneously operatable SRAMs determined by the simultaneous operation number determination section.

9. The design tool as set forth in claim 6, further comprising a test circuit generation section for setting a test circuit for testing the semiconductor device in the semiconductor device, wherein the test circuit generation section sets the test circuit such that the number of simultaneously operating SRAMs during the test is equal to or less than the number of simultaneously operatable SRAMs determined by the simultaneous operation number determination section.

10. A design method for a semiconductor device having plural SRAMs in one chip, comprising the steps of:
estimating AC noise produced by the simultaneous operation of the SRAMs; and
performing design such that the estimated AC noise is less than the permitted amount of noise.

11. The design method as set forth in claim 10, wherein the permitted amount of noise is calculated from the layout data of the semiconductor device.

12. The design method as set forth in claim 11, wherein the permitted amount of noise is defined as the maximum value of an amount of noise with which the circuit of the semiconductor device does not malfunction.

13. The design method as set forth in claim 10, wherein the AC noise during the simultaneous operation of the SRAMs is estimated from the amount of change in current stored in a library that has defined the amount of change in current during the operation of the SRAMs.

14. The design method as set forth in claim 10, wherein the layout data is recreated when the estimated AC noise is greater than the permitted amount of noise.

15. The design method as set forth in claim 10, wherein the number of simultaneously operatable SRAMs is determined such that the estimated AC noise is less than the permitted amount of noise.

16. The design method as set forth in claim 15, wherein:
the semiconductor device comprises a gating circuit for controlling supply of a clock to each SRAM; and
the gating circuit is set such that the number of simultaneously operating SRAMs is equal to or less than the number of simultaneously operatable SRAMs.

17. The design method as set forth in claim 16, wherein:
the semiconductor device further comprises a timing buffer circuit for controlling supply timing of the clock to each SRAM; and
the timing buffer circuit is set such that the number of simultaneously operating SRAMs is equal to or less than the number of simultaneously operatable SRAMs.

18. The design method as set forth in claim 15, wherein:
a test circuit for testing the semiconductor device is set in the semiconductor device; and
the test circuit is set such that the number of simultaneously operating SRAMs during the test is equal to or less than the number of simultaneously operatable SRAMs.

19. A program for causing a computer to perform design for a semiconductor device having plural SRAMs in one chip, causing a computer to perform:
simultaneous operation noise amount calculating processing for estimating AC noise produced by the simultaneous operation of the SRAMs;
processing for determining the number of simultaneously operatable SRAMs such that the estimated AC noise is less than the permitted amount of noise; and
design such that the estimated AC noise is less than the permitted amount of noise.
